(19) United States
(12) Patent Application Publication
(10) Pub. No.: US 2020/0333895 A1
(43) Pub. Date: Oct. 22, 2020

(54) INPUT COMPONENT ON STYLUS

(71) Applicant: Lenovo (Singapore) Pte. Ltd., Singapore (SG)

(72) Inventors: Madison Kay Smith, Manhattan Beach, CA (US); Cuong Huy Truong, Cary, NC (US); Brian Hargrove Leonard, Chapel Hill, NC (US)

(21) Appl. No.: 16/389,976

(22) Filed: Apr. 21, 2019

(51) Int. Cl. G06F 3/0354; G06F 3/0362

(52) U.S. Cl. CPC G06F 3/03545; G06F 3/0362

(57) ABSTRACT

One embodiment provides a stylus, including: a processor; an input component, wherein the input component is rotatable and depressable; a memory device that stores instructions executable by the processor to: detect input provided to the input component; determine an input type associated with the input; and transmit an indication of the input type to an information handling device. Other aspects are described and claimed.

### BACKGROUND

Users may interact with their information handling devices (“devices”), for example tablets, smart phones, laptop computers, hybrid devices, and the like, a plurality of different ways. For instance, users may choose to provide input to their device by using an input tool such as a stylus. Conventionally, the stylus is shaped like a pen or pencil and a tip of which may be contacted against, or held within a predetermined distance of, a display surface of a device to facilitate input provision. Common types of input provided using a stylus includes drawing input and selection input.

### BRIEF SUMMARY

In summary, one aspect provides a stylus, comprising: a processor; an input component, wherein the input component is rotatable and depressable; a memory device that stores instructions executable by the processor to: detect input provided to the input component; determine an input type associated with the input; and transmit an indication of the input type to an information handling device.

Another aspect provides a method, comprising: detecting input provided to an input component of a stylus; determining, using a processor, an input type associated with the input; and transmitting, responsive to the detecting, an indication of the input type to an information handling device; wherein the input component is rotatable and depressable.

A further aspect provides a method, comprising: receiving, at an information handling device and from a stylus, an indication of an input type that has been detected at an input component of the stylus; determining, using a processor, a function to be performed on the information handling device based on the input type; and performing, based on the determining, the function; wherein the type of the user input comprises one of rotation input or push input.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of determining an input type of input provided to an input component of a stylus.

FIG. 4(A-B) illustrates an example embodiment of an input component on a stylus.

FIG. 5 illustrates an example method of determining a function to perform on a device based upon the input type of input provided to an input component of a stylus.

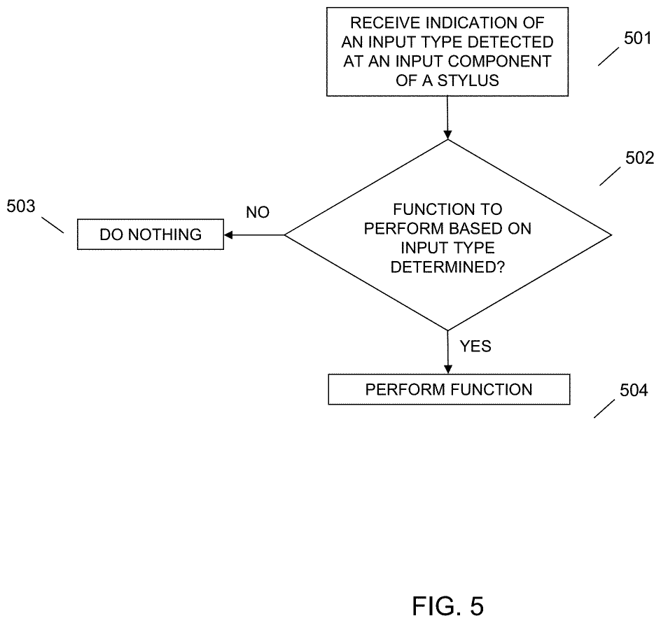

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Many user devices are compatible with a stylus that may be used to augment the user input experience. For example, a stylus may be utilized to increase the precision with which content is selected. This benefit may be especially important when objects are positioned close together (e.g., words in a document, icons on a home screen, buttons on a menu, etc.). As another example, a stylus may be used when a user desires finer handwriting and/or drawing controls (e.g., when drawing or painting, when providing comments to a document, when highlighting or editing, etc.).

Although conventional styli allow a user to access the software of the system directly and/or to access buttons on the hardware directly, current solutions do not offer ways for users to directly control certain aspects of the device, or content on the device, remotely. More particularly, as an example, a user wanting to adjust the volume of a device would conventionally need to navigate through the volume controls of the system (e.g., by finding the volume menu and thereafter adjusting a volume setting to a desired level, etc.). As another example, a user wanting to pause or stop a video would need to use their stylus to tap on the video or select a “pause” or “stop” button associated with the video interface. The foregoing direct interaction requirements between the stylus and the device may make it burdensome for the user to provide certain types of inputs.

Accordingly, an embodiment provides a method for providing input to a device via interaction with an input component integrated into the stylus. In an embodiment, a stylus may comprise an input component (e.g., at a position where a conventional pencil eraser is located, etc.). The input component may be both depressable and rotatable. Stated differently, a user may either push the input component so that it depresses into the stylus or, alternatively, the user may rotate the input component (e.g., clockwise or counter clockwise, etc.) so that it turns. The nature of a user's interaction with the input component may control a function on the device. For example, if a user pushes the input component into the stylus, an indication may be generated that informs the device to pause currently playing media (e.g., a song, a video, etc.). As another example, if a user turns the input component in a clockwise fashion, an indication may be generated that informs the device to increase its volume output levels. Such a method may provide users with an ability to control content on a device from their stylus remotely.

The illustrated example embodiments will be best understood by reference to the figures. The following description is intended only by way of example, and simply illustrates certain example embodiments.

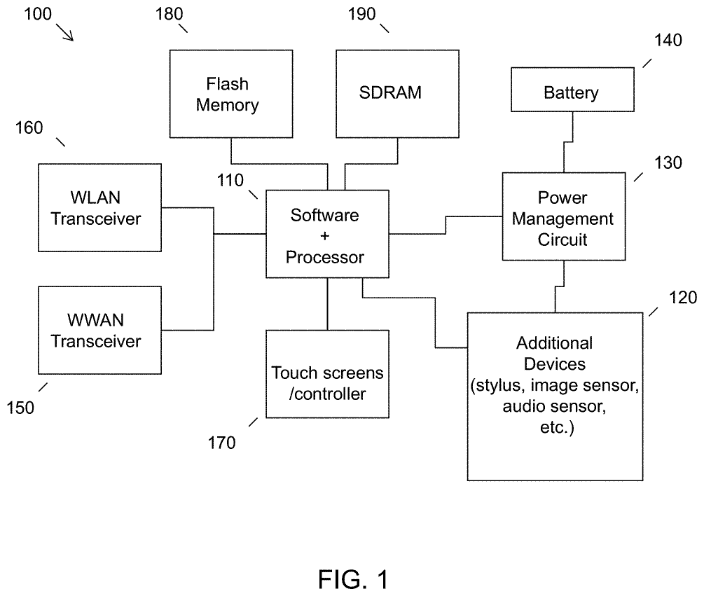

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an input device such as a stylus, image sensor such as a camera, audio capture device such as a microphone, external keyboard, other input devices, etc. System 100 often includes one or more touch screens 170 for data input and display/rendering. System 100 also typically includes various memory devices, for example flash memory 180 and SDRAM 190.

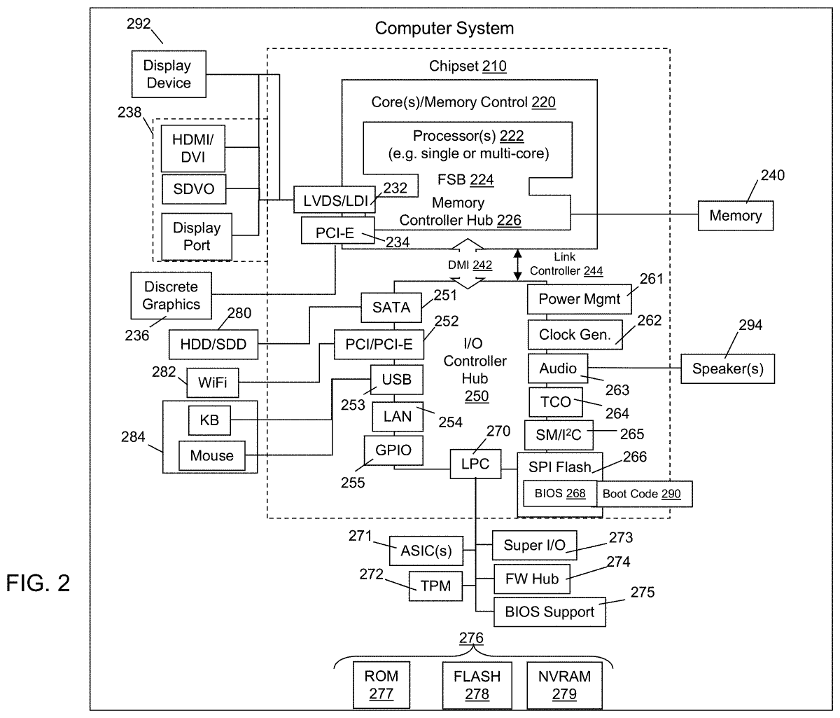

FIG. 2 depicts a block diagram of another example of information handling device circuits, circuitry or components. The example depicted in FIG. 2 may correspond to computing systems such as the THINKPAD or YOGA series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as smart phones, tablets, laptops, hybrid devices, and/or other electronic devices that may be compatible with a stylus. For example, the circuitry outlined in FIG. 1 may be implemented in a tablet or smart phone embodiment, whereas the circuitry outlined in FIG. 2 may be implemented in a laptop.

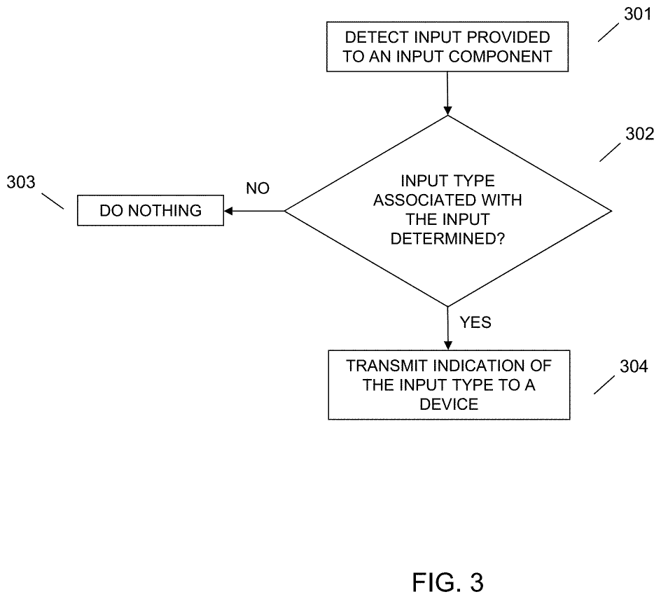

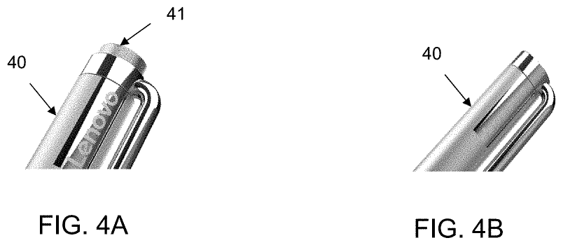

Referring now to FIG. 3, an embodiment may detect user input provided to an input component of a stylus and thereafter transmit an indication of that input to a device. At 301, an embodiment may detect input provided to an input component of a stylus. Referring now to FIG. 4(A-B), an example illustration of an input component 41 of a stylus 40 is illustrated. In the illustrated embodiment, the input component 41 is circular shaped and is located at a terminal end of the stylus 40 (e.g., at a position where a conventional pencil eraser is located, etc.). It is important to note that the shape and the location of the input component 41 in FIG. 4(A-B) is not limiting, and that those skilled in the art will recognize that the input component 41 may be placed at another position on the stylus 40 and may adopt virtually any another shape (e.g., square shape, oval shape, triangle shape, etc.).

In an embodiment, the input component may be depressable. More particularly, a user may exert force to the top of the input component (e.g., by pressing with their finger, etc.) to depress the input component from a protruding configuration, illustrated in FIG. 4A, to a depressed configuration, illustrated in FIG. 4B. In the protruding configuration, substantially all of the input component may be visible and may protrude from the terminal end of the stylus. In the depressed configuration, all, or a portion of, the input component may be lowered into a housing of the stylus (not illustrated). In an embodiment, the input component may be held in the depressed configuration by an inner holding component (not illustrated) until a similar force is exerted to the top of the input component. When such a force is received, the input component may revert back to protruding configuration in FIG. 4A. Additionally to the foregoing, the input component may also be rotatable. More particularly, when the input component is in the protruding configuration, as illustrated in FIG. 4A, a user may rotate the input component clockwise or counter-clockwise.

At 302, an embodiment may determine an input type associated with the input to the input component. More particularly, an embodiment may determine whether push input or rotation input was provided to the input component. Responsive to not determining, at 302, an input type associated with the input, an embodiment may, at 303, take no additional action. Conversely, responsive to determining, at 302, an input type associated with the input, an embodiment may, at 304, transmit an indication of the determined input type to a connected device. In an embodiment, the device may be wirelessly connected to the stylus (e.g., using a BLUETOOTH connection, a near-field communication (“NFC”) connection, another type of wireless connection, etc.).

In an embodiment, a function to be performed on the device, based on the input type, may also be transmitted to the device (e.g., concurrently with the transmission of the input type, etc.). More particularly, each input type may be associated with one or more functions to be performed on the device. For example, push input that depresses the input component to the depressed configuration may be associated with a pause or stop function that, when transmitted to the device, may pause or stop media playing on the device. In a similar embodiment, if push input is provided to the input component in the depressed configuration to change it to the protruding configuration, an embodiment may transmit an indication to the device to resume playing of any paused or stopped media. Other functions associated with the push input not explicitly described here may also be performed by the device (e.g., select/deselect functions, etc.). As another example, rotation input provided to the input component in the protruding configuration may be associated with a volume adjustment function, a zoom in or out function, etc. Other functions associated with the rotation input not explicitly described here may also be performed by the device. In an embodiment, the functions associated with each input type may be stored at an accessible storage location (e.g., stored locally on the stylus, stored remotely on another device or server, etc.).

Additionally or alternatively to the foregoing, rather than receiving the function information from the stylus, a device itself may determine which function to perform. In this situation, an embodiment may receive, at 501, an indication of a type of input provided to the input component of a connected stylus. An embodiment may then determine, at 502, a function to be performed, at 504, based on the input type. The determination may be solely based on identifying a function stored in an accessible list that is associated with the input type. Additionally or alternatively, the determination may also factor in one or more other considerations. For instance, an embodiment may tailor the function based upon the nature of the application that was open/active when input was provided to the input component. For example, if a media player was open when push input was provided to the input component, an embodiment may pause the media. Alternatively, if an application comprising a confirmation button was open when push input was provided to the input component, an embodiment may perform a select function on the confirmation button. As another example, if a media player was open when rotation input was provided to the input component, an embodiment may increase or decrease the volume of the media based upon the direction of the rotation input. Alternatively, if an image displaying/editing application was open when rotation input was provided to the input component, an embodiment may zoom in or out of any displayed images based upon the direction of the rotation input.

The various embodiments described herein thus represent a technical improvement to conventional stylus-based input techniques. Using the techniques and devices described herein, an embodiment may first detect user input provided to an input component of a stylus. An embodiment may then identify a type of the user input (e.g., push input or rotation input) and may thereafter transmit an indication of the input type to a device. A device may use the input type information to perform a function on content in an application. In an embodiment, the function may be based on the input type, a configuration of the input component when user input to the component was detected (e.g., depressed configuration vs protruding configuration, etc.), and/or a nature of an active application (e.g., media playing application vs image displaying application, etc.). Such a method and device may allow a user to remotely control various functions of a device, or application on the device, by simply manipulating the input component of the stylus.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A stylus, comprising:
a processor;
an input component, wherein the input component is rotatable and depressable;
a memory device that stores instructions executable by the processor to:
detect input provided to the input component;
determine an input type associated with the input; and
transmit an indication of the input type to an information handling device, wherein a function performed on the information handling device responsive to receipt of the indication is dictated based upon an active application.

2. The stylus of claim 1, wherein the input component is located at an end of the stylus.

3. The stylus of claim 1, wherein the instructions executable by the processor to determine comprise instructions executable by the processor to determine that the input type is associated with push input.

4. The stylus of claim 3, wherein the push input manipulates the input component between a protruding configuration and a depressed configuration, wherein the input component in the protruding configuration is positioned substantially outside of a housing of the stylus and wherein the input component in the depressed position is at least partially housed inside the housing of the stylus.

5. The stylus of claim 3, wherein the instructions executable by the processor to transmit comprise instructions executable by the processor to transmit an indication of a function to be performed on the information handling device based on the push input.

6. The stylus of claim 5, wherein the function is selected from the group consisting of a start function and a stop function.

7. The stylus of claim 1, wherein the instructions executable by the processor to determine comprise instructions executable by the processor to determine that the input type is associated with rotation input.

8. The stylus of claim 7, wherein the rotation input rotates the input component in a clockwise or a counter-clockwise direction.

9. The stylus of claim 7, wherein the instructions executable by the processor to transmit comprise instructions executable by the processor to transmit an indication of a function to be performed on the information handling device based on the rotation input.

10. The stylus of claim 9, wherein the function is selected from the group consisting of a volume increase function, a volume decrease function, a zoom in function, and a zoom out function.

11. A method, comprising:
detecting input provided to an input component of a stylus;
determining, using a processor, an input type associated with the input; and
transmitting, responsive to the detecting, an indication of the input type to an information handling device, wherein a function performed on the information handling device responsive to receipt of the indication is dictated based upon an active application;
wherein the input component is rotatable and depressable.

12. The method of claim 11, wherein the determining comprises determining that the input type is associated with push input.

13. The method of claim 12, wherein the push input manipulates the input component between a protruding configuration and a depressed configuration, wherein the input component in the protruding configuration is positioned substantially outside of a housing of the stylus and wherein the input component in the depressed position is at least partially housed inside the housing of the stylus.

14. The method of claim 12, wherein the transmitting comprises transmitting an indication of a function to be performed on the information handling device based on the push input.

15. The method of claim 12, wherein the function is selected from the group consisting of a start function and a stop function.

16. The method of claim 11, wherein the determining comprises determining that the input type is associated with rotation input.

17. The method of claim 16, wherein the rotation input rotates the input component in a clockwise or a counter-clockwise direction.

18. The method of claim 17, wherein the transmitting comprises transmitting an indication of a function to be performed on the information handling device based on the rotation input.

19. The method of claim 18, wherein the function is selected from the group consisting of a volume increase function, a volume decrease function, a zoom in function, and a zoom out function.

20. A method, comprising:
receiving, at an information handling device and from a stylus, an indication of an input type that has been detected at an input component of the stylus;
determining, using a processor, a function to be performed on the information handling device, wherein the function is dictated based upon an active application of the information handling device; and
performing, based on the determining, the function;
wherein the type of the user input comprises one of rotation input or push input.
